(19) United States
(12) Patent Application Publication
(10) Pub. No.: US 2019/0306116 A1
(43) Pub. Date: Oct. 3, 2019

(54) MULTIPLEXING SECURITY TUNNELS

(71) Applicant: Microsoft Technology Licensing, LLC, Redmond, WA (US)

(72) Inventors: Anirban Paul, Redmond, WA (US); Poornananda Gaddehosur Ramachandra, Redmond, WA (US); Shankar Seal, Bothell, WA (US); Anurag Saxena, Bellevue, WA (US); Arun Venkatachalam, Redmond, WA (US); Sai Krishna Goutham Bachu, Seattle, WA (US)

(21) Appl. No.: 15/937,831

(22) Filed: Mar. 27, 2018

(51) Int. Cl. H04L 29/06

(52) U.S. Cl. CPC H04L 63/029; H04L 63/0236; H04L 63/061; H04L 63/20; H04L 63/0272

(57) ABSTRACT

Embodiments relate to enabling clouds to multiplex their public network addresses among private addresses of IPSec gateways while making sure that IPSec tunnel packets are delivered to the private addresses of the IPSec tunnels that they are associated with. When IPSec packets egress from a cloud, the cloud may determine which IPSec tunnel or gateway the IPSec packets are associated with and modify the IPSec packets to identify the associated tunnel or gateway. When IPSec packets ingress to the cloud, the cloud may find identity information in the IPSec packets that identifies the associated tunnel or gateway. The identity information is used to direct the IPSec packets to the associated tunnel or gateway.

### BACKGROUND

When two hosts on different networks are to communicate over an insecure network such as the Internet, those hosts may require their communications to be secured as they transit the insecure network. It may be inconvenient for the hosts themselves to secure their communications. In such cases, the network facilities of the respective hosts may be used to secure the communications that they carry for the hosts. A common approach is to employ a security gateway such as the secure tunnel mode of the Internet Protocol (IP) Security protocol (IPSec), describe in RFC 7296 Section 1.1.1, which is commonly used to provide a site-to-site virtual private network (VPN). The IPSec gateway devices servicing the respective hosts' networks that provide this IPSec tunnel mode will be referred to herein as gateways.

Providing IPSec tunnels is straightforward for a pair of subnets (virtual or logical) and respective directly communicating gateways. However, in modern network deployments, administrators may deploy many subnets on different clouds, each potentially providing communication with the others across the Internet. Each cloud may host multiple tenant subnets and assign its own pool of gateways to secure traffic to/from these subnets. However, due to the limited pool of available Internet addresses and other reasons, these gateways may have to share a limited number of Internet-routable IP addresses. Typically, these gateways are deployed behind some kind of network multiplexor, which multiplexes the traffic between the different gateways. That is, a multiplexor may help multiple gateways with private addresses share a small pool of Internet addresses.

As observed only by the Inventors, this address-multiplexing approach gives rise to two fundamental problems. During IPsec tunnel establishment, the possibly-multiplexed IP addresses of the Internet Key Exchange (IKE) messages are used to choose the IKE policies that are used to negotiate the IKE Security Associations (SAs). However, as appreciated only by the inventors, since the IP addresses for IKE messages for different tunnel negotiations may be identical, there is ambiguity in choosing the correct policy and gateway to negotiate an SA. Put another way, IKE messages for two different tunnels may be indistinguishable based on their Internet addresses and therefore the tunnels have been unable to share the same Internet addresses.

The second problem discovered by the inventors stems from the fact that the different IPsec tunnels connecting the various tenant subnets among the Internet-separated clouds are tightly coupled with a specific pair of gateways. All IPsec traffic—both control (IKE) and data (Encapsulating Security Payload (ESP)/Authentication Header AH)) exchanges must always be routed between the gateway devices associated with the tunnels; at each end, the same gateway must handle all of a given tunnel's traffic, even if they might otherwise be interchangeable with respect to routing. But when the gateways share multiplexed Internet addresses, the IPsec traffic for different tunnels would be indistinguishable from each other at the network layer, as the datagram IP addresses would be same for all such packets. As the Inventors have observed, this creates ambiguity in how the packets are routed to the appropriate Gateway devices and until now prevents address sharing.

Techniques related to enabling IPSec tunnels over multiplexed Internet addresses are described below.

### SUMMARY

The following summary is included only to introduce some concepts discussed in the Detailed Description below. This summary is not comprehensive and is not intended to delineate the scope of the claimed subject matter, which is set forth by the claims presented at the end.

Embodiments relate to enabling clouds to multiplex their public network addresses among private addresses of IPSec gateways while making sure that IPSec tunnel packets are delivered to the private addresses of the IPSec tunnels that they are associated with. When IPSec packets egress from a cloud, the cloud may determine which IPSec tunnel or gateway the IPSec packets are associated with and modify the IPSec packets to identify the associated tunnel or gateway. When IPSec packets ingress to the cloud, the cloud may find identity information in the IPSec packets that identifies the associated tunnel or gateway (or security policy). The identity information is used to direct the IPSec packets to the associated tunnel or gateway.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows a first pair of IPSec gateways.

FIG. 2 shows a process by which a tunnel can be identified when its packets traverse a network using shared network addresses.

FIG. 3 shows where tunnel identification can occur.

FIG. 4 shows an embodiment for two different clouds that communicate via a common network.

FIG. 5 shows how static port numbers of tunnel packets can be used to add identification to site-to-site tunnel related communications.

FIG. 6 shows how a second packet completes the initiation shown in FIG. 5.

FIG. 7 shows details of a computing device on which embodiments described above may be implemented.

### DETAILED DESCRIPTION

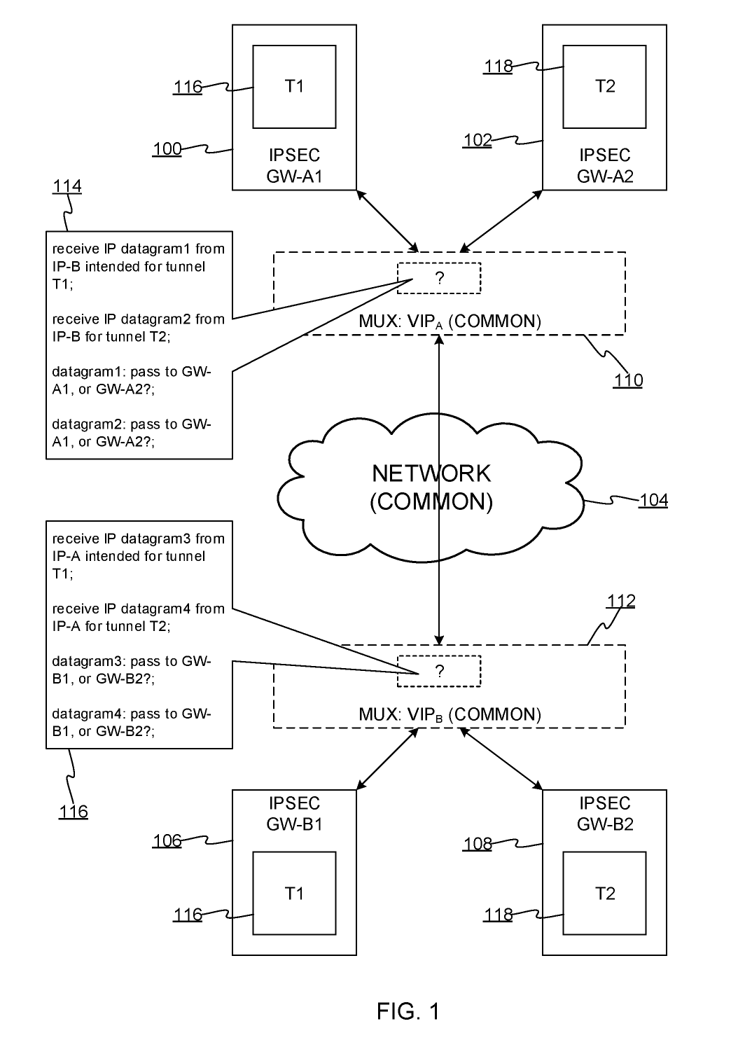

FIG. 1 shows a first pair of IPSec gateways 100, 102 (GW-A1, GW-A2) communicating via a network 104 with a second pair of IPSec gateways 106, 108 (GW-B1, GW-B2). The first pair of gateways 100, 102 share an Internet-routable IP address—VIP_{A}. VIP_{A} is multiplexed by a first multiplexor 110. Multiplexor 110 may use network address translation (NAT) techniques to translate inbound traffic to the correct addresses of the gateways behind it and to translate outbound traffic to the shared address VIP_{A}. Similarly, the second pair of gateways share another Internet-routable IP address—VIP_{B}. VIP_{B} is multiplexed by a second multiplexor 112. Multiplexor 112 allows the second gateways to share VIP_{B} by translating inbound traffic addressed to VIP_{B} to the addresses of the second gateways and translating the addresses of the second gateways' outbound traffic to the shared address VIP_{B}.

If the gateways implement the IPSec protocol to provide site-to-site tunnels, absent embodiments described herein, the following problems arise. Consider the first multiplexor 110 implementing process 114 for the IPSec protocol suite. The first multiplexor 110 may receive from the second multiplexor 112 an IPSec datagram1 intended for a first tunnel 116 associated with the first gateway 100. The first multiplexor also receives a second datagram2 from the second multiplexor 112 that is intended for a second tunnel 118 associated with the other first gateway 102. For datagram1, the first multiplexor must decide whether to pass it to first gateway 100 or first gateway 102. The same is true for datagram2: which gateway to address it to. However, as per the standard IPSec protocol and ordinary network translation, with respect to the first tunnel 116 and second tunnel 118, datagram1 and datagram2 are indistinguishable, from a network layer perspective. The multiplexor has no way to know which gateway should receive which datagram.

To clarify, the IPSec protocol specifies that the endpoints of a tunnel form an SA and the tunnel must flow through only those securely associated endpoints. The security association is, in effect, between the network addresses of the endpoints. A gateway will decide which datagrams belong to which tunnels based on “to” and “from” IP addresses of the datagrams. In the situation shown in FIG. 1, the first multiplexor 110 receives datagrams that have the same “to” and “from” addresses VIP_{A}/VIP_{B}. The first multiplexor 110 has no way to determine which SA or gateway the inbound datagrams belong to. The second multiplexor 112 has the same problem. The second multiplexor may have no way of determining which gateway datagram3 and datagram 4 should go to, or which tunnel or tenant they are associated with.

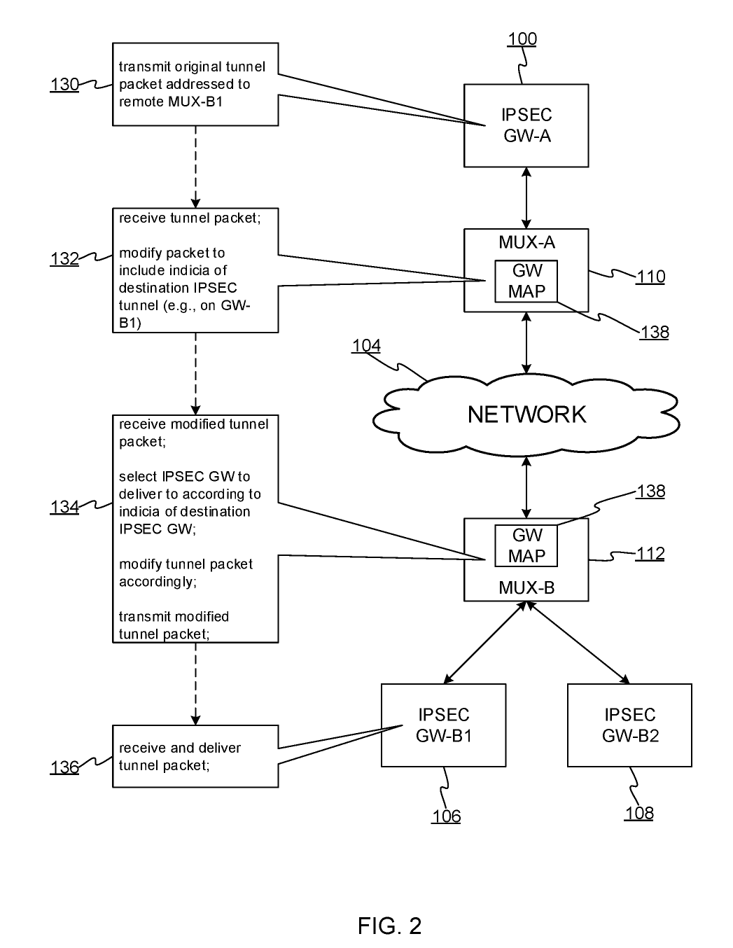

FIG. 2 shows a process by which a tunnel can be identified when it traverses a network using shared network addresses (e.g., public IP addresses). Because standard SAs are one-way, it is preferable for the initiator of a communication exchange, whether for an IKE transmission or and ESP/HA transmission (referred to as IPSec communications/packets hereafter), to inject into its IPSec communication an identifier for the relevant tunnel that can be used on the receiving side to differentiate between tunnels. Note that such marking can be used to identify a particular gateway or tenant, as these three entities are somewhat equivalent. Description will refer to tunnels with the understanding that other entities may be identified.

Returning to FIG. 2, it will be assumed that first gateway 100 is to initiate an IPSec communication, either for sending data or negotiating an SA. As step 130 the first gateway 100 receives a host or tenant packet to use or establish a site-to-site IPSec tunnel. The first gateway 100 has a corresponding original tunnel packet that is publicly addressed to remote second multiplexor 112 (addressed to VIP_{B}). The first gateway transmits the original tunnel packet to an internal interface of the first multiplexor. At step 132 the first multiplexor receives the original tunnel packet. The first gateway recognizes the tunnel packet and consequently proceeds to modify the tunnel packet to include indicia of the corresponding tunnel. Although the first multiplexor cannot directly control how the remote end responds, by including an identifier for the target tunnel, the sender enables the remote end to identify the target tunnel if it is appropriately configured etc.

At step 134, after the marked tunnel packet addressed to the second multiplexor 112 is routed through the common network 104 (where VIP_{A} and VIP_{B} are routable), the second multiplexor 112 receives the tunnel packet. The second multiplexor reads the tunnel identifier and selects the corresponding gateway (how this can be done is described below). For example, if the packet is marked as being for a particular tunnel, tenant, or gateway, the multiplexor, in addition to performing functions necessary for address-multiplexing, may modify the tunnel packet to assure that it is delivered to the appropriate gateway and, in some embodiments, to allow the receiving gateway to determine which tunnel the packet is associated with. At step 136, the multiplexor 112.

The multiplexors may maintain or access mapping information 138 which can be used to map the tunnel identifiers to the tunnel identifiers in the tunnel packets exchanged over the common network 104. The mapping information 138 may depend on how the tunnel identifiers are derived and/or are embedded in the tunnel packets. In some embodiments, mapping information is not needed and the opposing ends rely on conventions, static identifiers, combinations of header/packet information, etc.

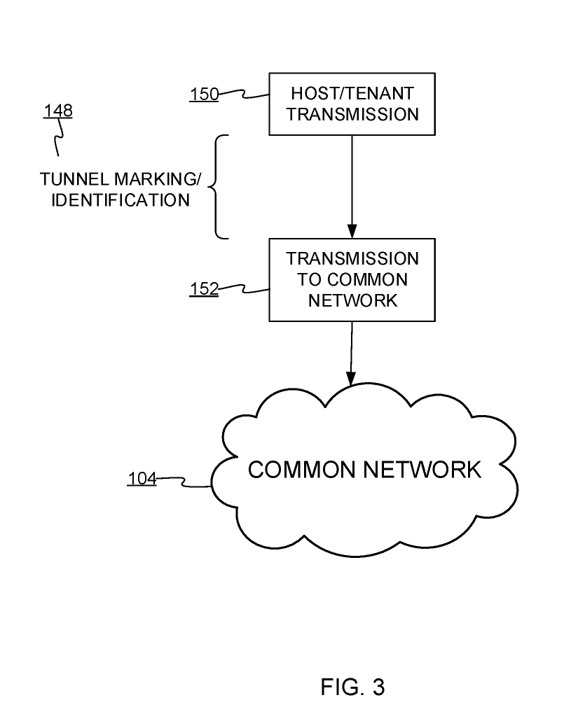

FIG. 3 shows where tunnel identification can occur. Although the modification of tunnel packets is described herein as occurring at address-multiplexing devices, as shown in FIG. 3, tunnel packet modification 148 may be performed at any point at or after a gateway (since an IPSec packet is formed at the gateway) and up to transmission to the common network. That is, packet marking or transformation can be done at any point before a packet leaves a cloud (for outbound packets) or at any point after a packet enters a cloud (for inbound packets). For example, a bump-in-the-line device or proxy server can be transparently employed, before or after the multiplexing device. Alternatively, the gateways may be provided with modules for modifying tunnel packets. Description of multiplexor tunneling functionality herein is applicable to any possible point of implementation. Moreover, the same flexibility of placing the tunneling functionality applies to the receiving/responding side. The responding side may recognize and act on a tunnel packet's tunnel identifier at any point between receipt from the common network 104 to delivery by a IPSec gateway.

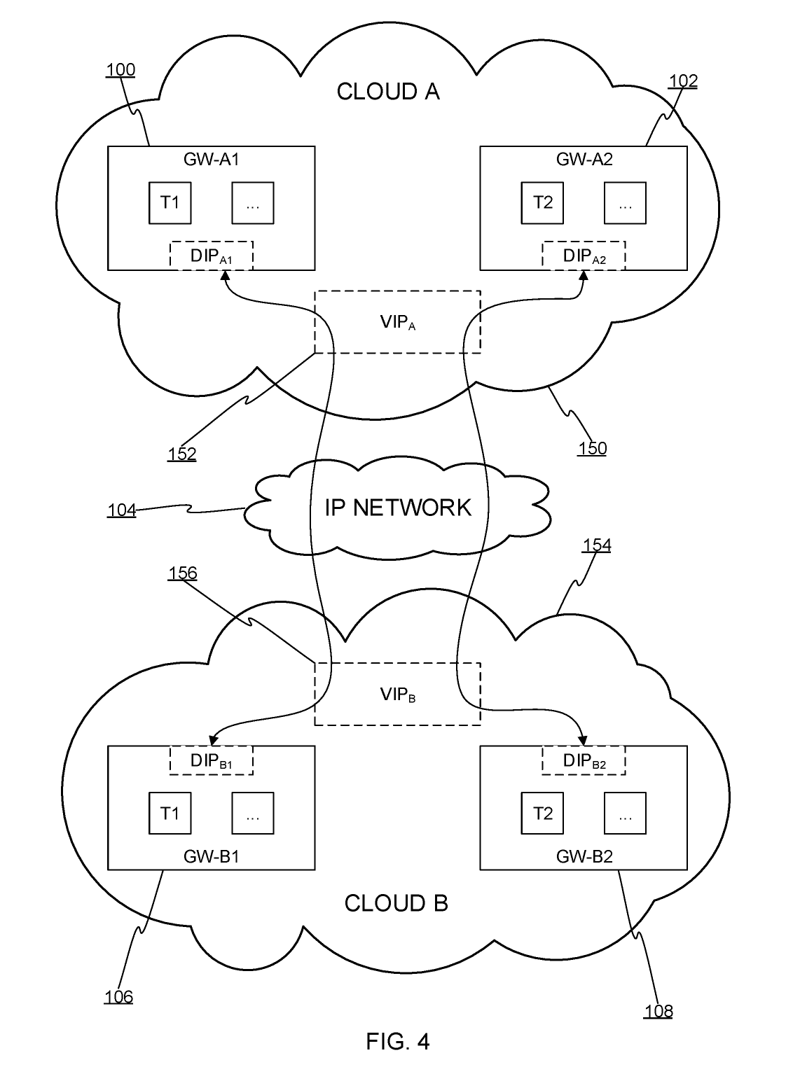

FIG. 4 shows an embodiment for two different clouds that communicate via the common network 104. Cloud A 150 may have one or more first IP addresses 152 that are shared among first gateways 100, 102. In the example of FIG. 4, the cloud A gateways share at least VIP_{A}. First gateway 100 has an internal address DIP_{A1}, and first gateway 102 has an internal address DIP_{A2}. Similarly, cloud B 154 may multiplex one or more IP addresses 156, including at least VIP_{B}, which is shared among the second gateways 106, 108. The gateways of the clouds may provide routing for private tenant subnets from which tunnels and traffic carried thereby originate.

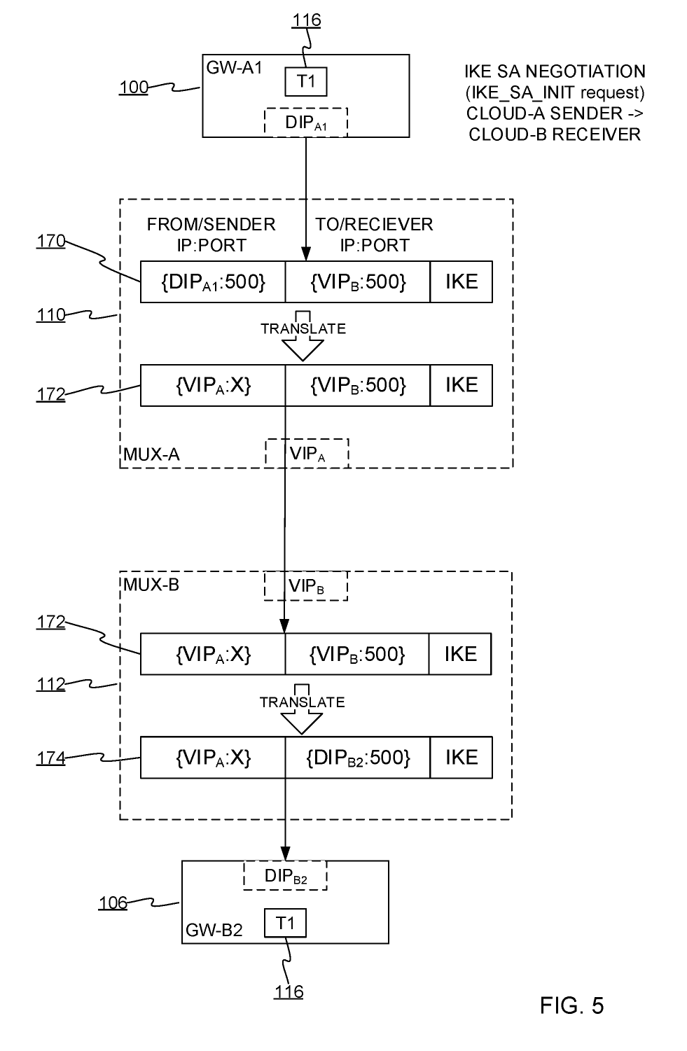

FIG. 5 shows how static port numbers of tunnel packets can be used to add identification to site-to-site tunnel related communications. The example of FIG. 5 is for an IKE SA negotiation, although extension of the technique to other exchanges will be apparent. When cloud A determines that a first tunnel 116 (T1) is needed, the first gateway 100 sends a first packet 170 to the first multiplexor 110 (or other point as mentioned above). The first multiplexor 110 recognizes the first packet 170 as an IKE packet, the first multiplexor decides what identifier to use for the corresponding tunnel. In this example, the identifier is “X”, which could be any valid practical port number. The first multiplexor replaces the “from” port “500” in the first packet with “X” and changes the “from” address from DIP_{A1} to VIP_{A}. The modified first packet 172 is then transmitted from an interface for VIP_{A}. The modified first packet 172 is routed through the common network 104 to the second multiplexor 112.

The second multiplexor 112 (or another asset, as discussed above) receives the modified second packet 172. The modified second packet 172 is analyzed and recognized as a tunnel packet (an IKE packet, in this example). Consequently, the tunnel identifier is extracted from the modified first packet 172. Although the port number is helpful for identifying a tunnel, the addresses of the modified first packet 172 may also help to identify the tunnel. The second multiplexor 112 recognizes the identifier and, according thereto, determines which gateway in cloud B the modified first packet should be addressed to, namely, DIP_{B2} for second gateway 106. The second multiplexor 112 maps the identifier (port X in this case) to the correct gateway instance. The packet is updated with the address of the correct gateway (second gateway 106). The second multiplexor 112 then transmits the again-modified first packet from an internal interface to the second gateway 106. The second gateway is 106 is assured that it has received a packet for an SA attached/attaching to the second gateway 106. The use of “from” data to identify the tunnel enables the first packet to be properly routed through the common network but also carry additional information about the tunnel or gateway that can be used by cloud B.

The port number “X” in FIG. 5 can be statically or dynamically determined by the sending side. In the static case, both ends know in advance which ports correspond to which tunnels, tenants, or gateways. The ports may be pre-configured in security policies, and when the SA is negotiated. Specifically, with the static port approach, when tunnel T1 is configured between VIP_{A} and VIP_{B} the port X is read from a policy and an associated NAT rule is configured to point to DIP_{B2} of GW-B2. In the dynamic port approach, a hash may be computed of the 3-tuple (source IP, source port, and destination IP), and the hash resolves to DIP_{B}2 of GW-B2. In either case, at cloud B, the incoming modified first packet is translated to be addressed to the correct gateway address—DIP_{B}2. On the second gateway the thus-transformed packet indicates the need for IKE service. By the RFC (Request For Comment) standard (see section 3.12 of RFC 7296), the IKE service is required to receive packets from any remote port and must send its response to the same remote port (X in this case), thus maintaining the port-tunnel association on both ends.

To elaborate on the dynamic port approach, the port reservation is dynamic in nature and is associated by the NAT (or equivalent component) to a particular gateway. Since multiple tunnels may terminate on the same gateway, such ports are not unique to a tunnel. But, it is unique to a gateway, across all gateways in a cloud deployment. The dynamic port approach implicitly assumes that every gateway device is configured with policies for all tunnels in that cloud deployment.

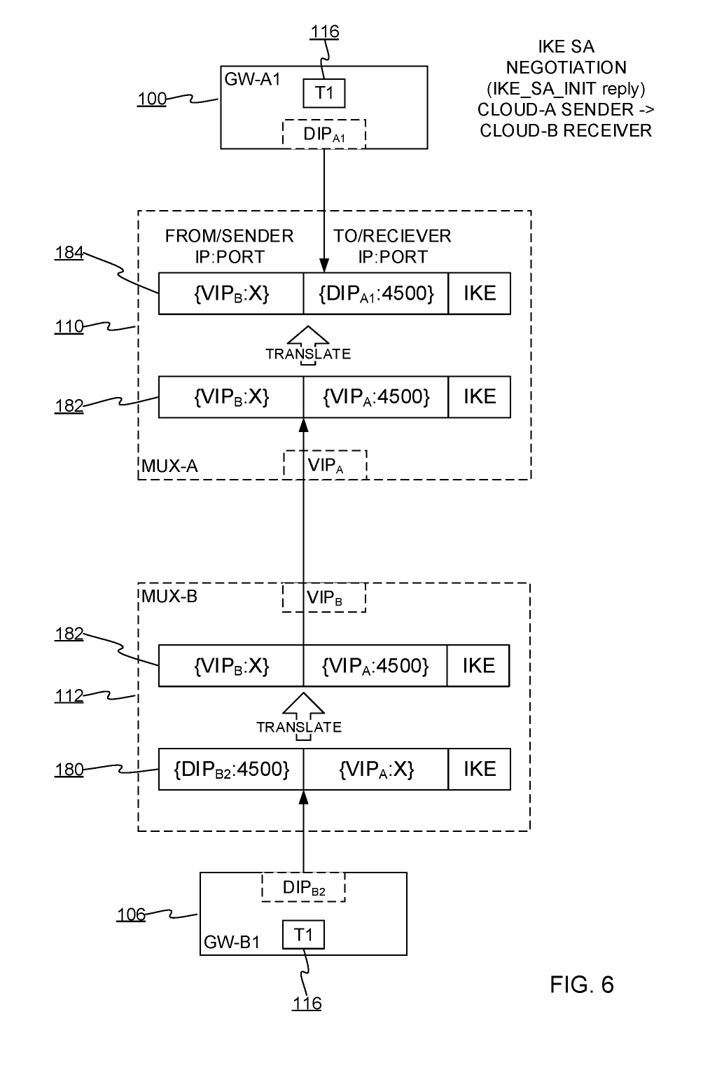

FIG. 6 shows how a second packet 180 completes the initiation shown in FIG. 5. The responder in the second gateway 106 uses NAT detection in the IKE message (per section 2.23 in RFC 7296) and determines that the first and second gateways are behind a NAT layer, and consequently switches to using UDP port “4500” for future IKE messages. The second gateway 106 creates a second packet 180, in this example, the response to the SA initialization packet from cloud A. The outbound second packet 180 is intercepted by the second multiplexor 112, which recognizes the source and port and translates the second packet 180 to a modified second packet 182 by changing: the “from” address from the second gateway's (DIP_{B2}) to that of the multiplexed public address of cloud B (VIP_{B}), the “from” port from “4500” to “X”, and the “to” port from “X” to “4500”. The modified second packet 182 is then transmitted over the common network from the interface for VIP_{B} to the interface for VIP_{A}. Cloud A then receives the modified second packet 182 (the IKE_SA_INIT response) in the same way that cloud B received the modified first packet, ultimately delivering the response to the correct gateway for the identified, tunnel, i.e., the first gateway 100.

Data packets (ESP packets) will also be encapsulated with UDP:4500. See RFC 7295, section 2.23 explaining why ESP packets would be UDP encapsulated. Data packets (UDP encapsulated ESP) will be transformed as follows, where “⇒” denotes a translation at a cloud, and where “{a:b, c:d}” denotes “from address a:port b, and to address c:port d”, and where the packets are marked as UDP encapsulated ESP packets.
When a tunnel packet egresses from cloud A:
   Cloud A: {DIP_{A1}:4500, VIP_{B}:X}⇒{VIP_{A}:X, VIP_{B}:4500}.
When the tunnel packet ingresses at cloud B:
   Cloud B: {VIP_{A}:X, VIP_{B}:4500}⇒{VIP_{A}:X, DIP_{B2}:4500}.
When a tunnel packet egresses from cloud B:
   Cloud B: DIP_{B2}:4500, VIP_{A}:X}⇒{VIP_{B}:X, VIP_{A}:4500}.
When the tunnel packet ingresses at cloud A:
   Cloud A: {VIP_{B}:X, VIP_{A}:4500}⇒{VIP_{B}:X, DIP_{A1}:4500}.

If another IPSec tunnel is needed, say a second tunnel T2 118, the second tunnel T2 may be handled as follows. Suppose that second gateway 106 (GW-B1) in cloud B initiates negotiation for the second tunnel T2 118. Suppose also that in this case it is port Y that is reserved for NAT-ing. Then all IKE and UDP encapsulated ESP packets for tunnel T2 118 will have source port Y. Further suppose that the other first gateway 102 (GW-A2) in Cloud A is selected for this port. Then all packets for tunnel T2 will flow between the other first gate 102 (GW-A2) and the second gateway 108 (GW-B1) without interfering with any traffic of tunnel T1.

As can be seen from FIGS. 5 and 6, regardless of the whether a static or dynamic approach is taken, IPSec exchanges involve a component at the transmitting side adding a tunnel identifier before an outbound tunnel packet is transmitted from a shared address routable on the common network. The receiving side can use the identifier to make sure that the tunnel packet goes to the gateway where the corresponding SA has been established.

Other embodiments, described next, may be used to negotiate multiple tunnels between a same pair of IP addresses.

A tunnel identifier (ID) is to be used to identify each tunnel. The Tunnel ID uniquely identifies an IPsec tunnel across all tunnels configured in all gateways in the relevant clouds. The tunnel ID may be a globally unique identifier, a friendly string, or computed as a hash of various unique elements of the IKE policy. The tunnel ID should be known (or derivable independently) on the two gateways between which a given tunnel is to be established.

Regarding the IKE_SA_INIT exchange, the two involved IKE peers negotiate the IKE SA. The initiator selects an IKE policy to use for the tunnel that is being established. With the static port approach, the NAT port is configured within the IKE policy. The IKE responder looks at the 3-tuple (Source IP, Source Port and Destination IP) of the incoming IKE message to find the matching IKE policy. With the dynamic port approach, the 3-tuple is not guaranteed to be unique to a tunnel in a Gateway. In this case, to pass the tunnel ID of the tunnel being established, the initiator sends a vendor ID payload (section 3.12 of RFC 7296) in the IKE_SA_INIT message.

Regarding the IKE_SA_AUTH exchange, for the static port approach, as with the IKE_SA_INIT exchange, the 3-tuple (source IP, source port, destination IP) can be used to uniquely identify the IPsec policy. For the dynamic port approach, the tunnel ID can be passed to in the IDi (initiator ID) and optional IDr (responder ID) payload to identify the tunnel being established and to choose the appropriate IPsec policy to negotiate the child SA. The ID payloads are used in IKE_SA_AUTH exchange as follows (fields are described in the RFC):

HDR, SK {IDi, [IDr, ]AUTH, SAi2, TSi, TSr} is sent, and

HDR, SK {IDr, AUTH, SAr2, TSi, TSr} is sent in reply.

Per section 3.5 of RFC 7296, the following identity-type is allowed to pass vendor-specific information: ID_KEY_ID. An opaque octet stream that may be used to pass vendor-specific information necessary to do certain proprietary types of identification. The initiator will use this for the IDi payloads. The responder will use this ID payload to find the right matching policy, which is used for child SA negotiation and to validate the AUTH payload (for shared secret-based authentication). CREATE_CHILD_SA exchanges are used to create new child SAs (of the SA established above) and to rekey both IKE SAs and child SAs. This will use the same pattern as IKE_SA_AUTH exchange.

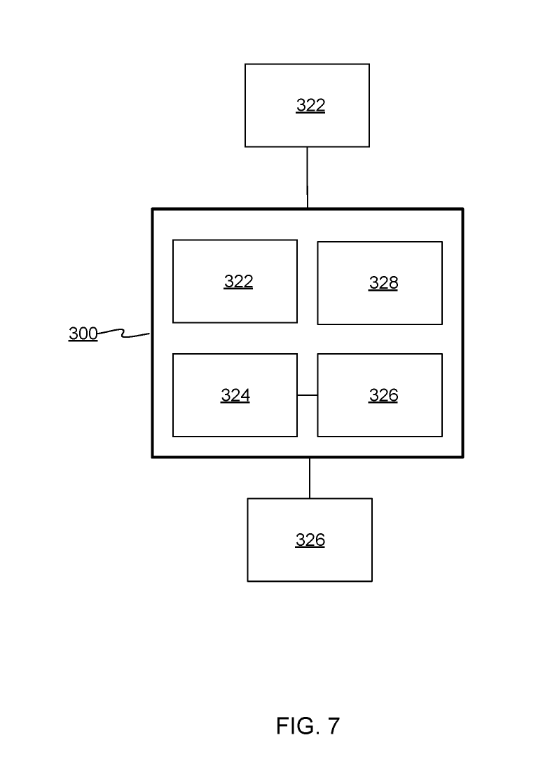

FIG. 7 shows details of a computing device 300 on which embodiments described above may be implemented. The computing device 300 is an example of a client/personal device or backend physical (or virtual) server devices that may perform various (or perhaps most) of the processes described herein. The technical disclosures herein will suffice for programmers to write software, and/or configure reconfigurable processing hardware (e.g., field-programmable gate arrays (FPGAs)), and/or design application-specific integrated circuits (ASICs), etc., to run on the computing device 300 (possibly via cloud APIs) to implement the embodiments described herein.

The computing device 300 may have one or more displays 322, a camera (not shown), a network interface 324 (or several), as well as storage hardware 326 and processing hardware 328, which may be a combination of any one or more: central processing units, graphics processing units, analog-to-digital converters, bus chips, FPGAs, ASICs, Application-specific Standard Products (ASSPs), or Complex Programmable Logic Devices (CPLDs), etc. The storage hardware 326 may be any combination of magnetic storage, static memory, volatile memory, non-volatile memory, optically or magnetically readable matter, etc. The meaning of the term “storage”, as used herein does not refer to signals or energy per se, but rather refers to physical apparatuses and states of matter. The hardware elements of the computing device 300 may cooperate in ways well understood in the art of machine computing. In addition, input devices may be integrated with or in communication with the computing device 300. The computing device 300 may have any form-factor or may be used in any type of encompassing device. The computing device 300 may be in the form of a handheld device such as a smartphone, a tablet computer, a gaming device, a server, a rack-mounted or backplaned computer-on-a-board, a system-on-a-chip, or others.

Embodiments and features discussed above can be realized in the form of information stored in volatile or non-volatile computer or device readable media. This is deemed to include at least media such as optical storage (e.g., compact-disk read-only memory (CD-ROM)), magnetic media, flash read-only memory (ROM), or any current or future means of storing digital information. The stored information can be in the form of machine executable instructions (e.g., compiled executable binary code), source code, bytecode, or any other information that can be used to enable or configure computing devices to perform the various embodiments discussed above. This is also deemed to include at least volatile memory such as random-access memory (RAM) and/or virtual memory storing information such as central processing unit (CPU) instructions during execution of a program carrying out an embodiment, as well as non-volatile media storing information that allows a program or executable to be loaded and executed. The embodiments and features can be performed on any type of computing device, including portable devices, workstations, servers, mobile wireless devices, and so on.

1. A method of transmitting Internet Protocol Security (IPSec) tunnel packets comprising:
transmitting first tunnel packets and second tunnel packets from cloud A to a common network that connects cloud A and cloud B, the first tunnel packets comprising first headers and the second tunnel packets comprising second headers, the first and second headers addressed from a first common address corresponding to cloud A, the first and second headers addressed to a second common address corresponding to cloud B, the first and second addresses in an address space of the common network, the first and second tunnel packets routable through the common network from cloud A to cloud B due to the first and second common addresses of the first and second tunnel packets; and
before transmitting the first and second tunnel packets to the common network, modifying the first headers to include a first gateway identifier identifying a first gateway of cloud B, and modifying the second headers to include a second gateway identifier identifying a second gateway of cloud B.

2. A method according to claim 1, wherein the first tunnel packets comprise packets of a first site-to-site IPSec tunnel that terminates at the first gateway, and wherein the second tunnel packets comprise packets of a second site-to-site IPSec tunnel that terminates at the second gateway.

3. A method according to claim 2, wherein the modifying comprises changing from-port numbers of the first headers to the first gateway identifier and changing from-port numbers of the second headers to the second gateway identifier.

4. A method according to claim 1, wherein the first and second headers comprise a standard to-port number of the IPSec protocol.

5. A method according to claim 1, wherein the first tunnel packets correspond to a first site-to-site IPSec tunnel terminating at the first gateway, the second tunnel packets correspond to a second site-to-site IPSec tunnel terminating at the second gateway, wherein the first gateway identifier comprises a first static identifier pre-configured at the first cloud and the second cloud prior to transmitting any packets related to the first IPSec tunnel, and wherein the second gateway identifier comprises a second static pre-configured at the first and second cloud prior to transmitting any packets related to the second IPSec tunnel.

6. A method according to claim 1, wherein the first tunnel packets correspond to a first site-to-site IPSec tunnel terminating at the first gateway, the second tunnel packets correspond to a second site-to-site IPSec tunnel terminating at the second gateway, wherein the first gateway identifier comprises a first dynamic value configured during negotiation of a first security association (SA) for the first tunnel, and wherein the second gateway identifier comprises a second dynamic value configured during negotiation of a second SA for the second tunnel.

7. A method according to claim 1, the method further comprising, at the second cloud:
receiving the first and second tunnel packets from the common network;
based on the first gateway identifiers in the first headers, addressing the first tunnel packets to a first internal address of the first gateway, the first internal address not routable on the common network; and
based on the second gateway identifiers in the second headers, addressing the second tunnel packets to a second internal address of the second gateway, the second internal address not routable on the common network.

8. A method according to claim 7, wherein the addressing the first tunnel packets comprises translating the second common network address of the second cloud to the first internal address of the first gateway and translating the second common network address of the second cloud to the second internal address of the second internal address of the second gateway.

9. A method performed at a second cloud, the method comprising:
receiving first tunnel packets of a first IPSec tunnel and second tunnel packets of a second IPSec tunnel, the first and second tunnel packets received from a common network connecting the first cloud with a second cloud, the first and second tunnel packets routed to the second cloud by the common network based on the first and second tunnel packets having a to-address that is an address of the second cloud routable on the common network, wherein the second cloud enables a first and second gateway thereof to share the address of the second cloud by multiplexing the address of the second cloud to a first internal address of the first gateway and to a second internal address of the second gateway;
determining to re-address the first tunnel packets from the address of the second cloud to the first internal address based on a first identifier in the first tunnel packets and determining to re-address the second tunnel packets from the address of the second cloud to the second internal address based on a second identifier in the second tunnel packets.

10. A method according to claim 9, wherein some of the first identifiers further identify the first tunnel and other of the first identifiers further identify a third tunnel, the first and third tunnels terminating at the first gateway.

11. A method according to claim 9, wherein the first identifier comprises a port number used by a first tenant of the first cloud and used by a second tenant of the second cloud, the method further comprising re-addressing the first tunnel packets based the port number.

12. A method according to claim 9, wherein the first and second tunnel packets comprise Internet Key Exchange (IKE) packets or Encapsulating Security Payload (ESP) packets.

13. A method according to claim 9, wherein when the first and second tunnel packets received by the second cloud they are addressed as being from an address of the first cloud according to which the first and second tunnel packets were routed through the common network, the first cloud comprising one or more other gateways that have security associations with the first and second gateways.

14. A method according to claim 9, wherein the first identifier comprises a hash of fields of headers of the first tunnel packets and wherein the second identifier comprises a hash of fields of headers of the second tunnel packets.

15. A method for enabling a cloud to multiplex IPSec packets from a common network address of the cloud to IPSec gateways of the cloud, the method comprising:
sending or receiving the IPSec packets to or from a common network, the IPSec packets routed to or from the common network according to their respective headers comprising the common network address; and
determining which tunnels and/or gateways the IPSec packets are associated with and, according thereto, multiplexing the IPSec packets between the common network address and addresses of the gateways.

16. A method according to claim 15, further comprising sending at least part of a tunnel identifier in an initiator or responder ID payload of an IKE_SA_AUTH message.

17. A method according to claim 15, wherein the first IPSec packets comprise a first tunnel identifier, wherein the second IPSec packets comprise a second tunnel identifier, the method further comprising maintaining associations between the first and second tunnel identifiers and respective first and second security policies;

18. A method according to claim 17, further comprising selecting the first security policy for handling the first IPSec packets according to either presence of the first identifier in the first IPSec packets or according to one or more fields of the first IPSec packets.

19. A method according to claim 15, wherein an initiator of an IPSec tunnel selects an IKE policy to be used by the cloud and a remote cloud, end points of the IPSec tunnel residing in the cloud and the other cloud, respectively.

20. A method according to claim 15, wherein the common network address is multiplexed by a multiplexor device that performs the method by operating only on network and transport headers of packets routed on the common network, and wherein the multiplexor device does not operate on IPSec headers.
